(19) United States
(12) Patent Application Publication
(10) Pub. No.: US 2017/0147363 A1
(43) Pub. Date: May 25, 2017

(54) SYSTEM AND METHOD FOR REDUCING HIBERNATE AND RESUME TIME

(71) Applicant: FREESCALE SEMICONDUCTOR, INC., Austin, TX (US)

(72) Inventors: Mingle Sun, Shanghai (CN); Chongbin Fan, Shanghai (CN); Yongcai Huang, Shanghai (CN)

(21) Appl. No.: 15/256,615

(22) Filed: Sep. 4, 2016

(30) Foreign Application Priority Data
Nov. 19, 2015 (CN) 201511035881.1

(51) Int. Cl. G06F 9/44; G06F 1/32

(52) U.S. Cl. CPC G06F 9/4418; G06F 1/3246; G06F 9/4406; G06F 9/442

(57) ABSTRACT

A method for conserving power in a computing device having a volatile system memory, a non-volatile storage device, and a processor executing an operating system and including an internal non-volatile memory (NVM). The method includes receiving, at the processor, a request to enter the computing device into a hibernation mode, suspending, by the processor, execution of the operating system, copying, by the processor, substantially the entire contents of the volatile system memory into the non-volatile storage device, storing, in the internal NVM of the processor, a hibernate flag, and turning off power to the computing device.

### BACKGROUND

The present invention is directed to low power states for a computing device and, more particularly, to a hibernation mode that reduces the time required to hibernate and resume operation from hibernation.

Computing devices, such as personal computers (PCs), laptops, notebooks, tablets, cellular phones, and the like often use operating systems that provide one or more low power states to allow a user to essentially turn the device “off,” and thereby save power, without requiring a full and complete reboot at the next power-on. For example, a computing device may utilize a conventional “hibernation” mode that allows the entire device to be powered down.

To achieve this state, a processor of the computing device will stop all active processes and save their states, and then create a “snapshot” of the operating system's state. The snapshot is saved to non-volatile storage (e.g., a hard disk drive or the like) before shutting down the power. If the computing device is subsequently unplugged or loses its power source (e.g., a battery is completely drained), the user can still resume to the same state as when the hibernation mode was initiated.

To resume from hibernation, the processor runs a boot program stored in read-only memory (ROM) to initiate the appropriate hardware and software components. A boot loader is then run to load the operating system into the processor for execution. A kernel of the operating system is thereafter initialized. The snapshot previously stored in the non-volatile storage is loaded into the operating system, which then runs from the previously saved state.

The operating system is basically restarting as if from a cold boot in order to load the snapshot. As a result, while the resume time is better than a cold boot, it is still comparatively long. Consequently, this mode is not often used on computing devices such as cell phones or tablets.

To enable faster resumption of the operating system, a “sleep” or “suspend” mode is typically provided. In this mode, the operating system is kept alive in a volatile system memory (e.g., dynamic random access memory (DRAM)), and is simply suspended after saving the states of active processes. The processor and certain other hardware components remain at least partially powered. In particular, the DRAM must remain powered in order to retain the data. While the resume time from suspend mode can be nearly instantaneous, a significant trade-off in battery consumption is realized.

It is therefore desirable to provide a low power mode for a computing device that permits a substantial, if not complete, cessation of supplied power while minimizing the time for resumption to an active state.

### BRIEF DESCRIPTION OF THE SEVERAL VIEWS OF THE DRAWINGS

The present invention is illustrated by way of example and is not limited by embodiments thereof shown in the accompanying figures, in which like references indicate similar elements. Elements in the figures are illustrated for simplicity and clarity and have not necessarily been drawn to scale.

In the drawings:

FIG. 1 is a schematic block diagram of an exemplary computing device for use with embodiments of the present invention;

FIG. 2 is a flow chart of a hibernation process in accordance with a preferred embodiment of the present invention; and

FIG. 3 is a flow chart of a resume process in accordance with a preferred embodiment of the present invention.

### DETAILED DESCRIPTION

In one embodiment, the present invention provides a method for conserving power in a computing device having a volatile system memory, a non-volatile storage device, and a processor executing an operating system and including an internal non-volatile memory. The method includes receiving, at the processor, a request to enter the computing device into a hibernation mode, suspending, by the processor, execution of the operating system, copying, by the processor, substantially an entire content of the volatile system memory into the non-volatile storage device, storing, in the internal non-volatile memory of the processor, a hibernate flag, and turning off power to the computing device.

In another embodiment, the present invention provides a computing device including a volatile system memory, a non-volatile storage device, and a processor executing an operating system and including an internal non-volatile memory. The processor is configured to receive a request to enter the computing device into a hibernation mode, suspend execution of the operating system, copy substantially an entire content of the volatile system memory into the non-volatile storage device, store, in the internal non-volatile memory, a hibernate flag, and turn off power to the computing device.

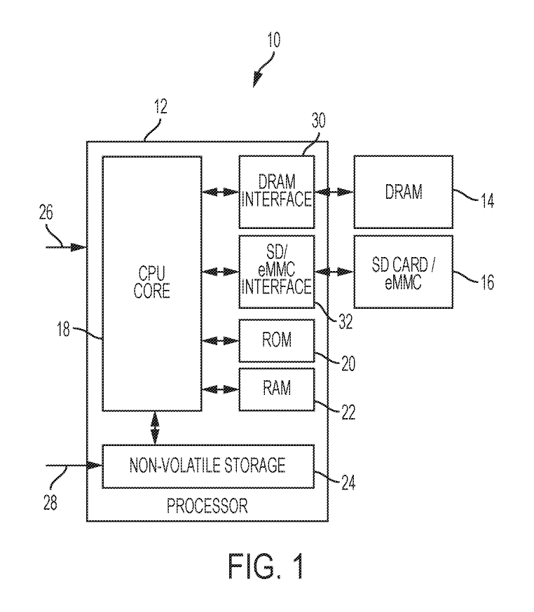

Referring now to the drawings, wherein the same reference numerals are used to designate the same components throughout the several figures, there is shown in FIG. 1 an embodiment of a computing device 10 in accordance with a preferred embodiment of the present invention. The computing system 10 preferably includes a processor 12, a volatile system memory 14, and a non-volatile storage device 16. The processor 12 preferably includes one or more central processing unit (CPU) cores 18 configured to execute the majority of programming of the computing device 10, including the basic operating system, as well as control operation of various hardware components (not shown) of the computing device 10, such as displays, user interfaces, speakers, microphones, communication modules, and the like.

The processor 12 preferably further includes a read-only memory (ROM) 20, which is configured to store at least the boot program and other programming related to system initialization. The processor 12 also preferably includes an internal volatile memory 22 (e.g., random access memory (RAM)). The internal volatile memory 22 is preferably configured for receiving and storing programs for start-up or resume operations and other basic functions to be performed by the processor 12 without using the volatile system memory 14. The processor 12 also preferably includes an internal non-volatile memory 24, which is preferably used to store flags or other data related to configurations or selections related to start-up or resume operations or other basic functions.

The processor 12 also includes at least one input for receiving power from a main power supply (not shown), which is typically a battery, but may also be another direct current (DC) power supply or an alternating current (AC) power supply. The computing device 10 may also include an alternative power supply (not shown) for powering minor circuits, such as a real-time clock (RTC) or the like. The processor 12 preferably includes an input 28 for the alternative power supply as well. Given the relatively low power consumption, the alternative power supply may or may not be shut down in hibernation mode according to embodiments of the present invention.

The volatile system memory 14 is preferably a dynamic random access memory (DRAM), although other types of volatile memory can be used as well, and serves as the storage and working space for the operating system and applications run by the processor 12. The processor 12 preferably includes a system memory interface 30 to allow the CPU core(s) 18 to control the volatile system memory 14.

The non-volatile storage device 16 may be a hard disk drive (HDD), particularly in PCs or laptops. However, in smaller devices such as tablets or cell phones, the non-volatile storage device 16 is preferably a type of flash memory, such as a Secure Digital (SD) card, an embedded MicroMediaCard (eMMC), or the like. The processor 12 preferably includes a non-volatile storage interface 32 to allow the CPU core(s) 18 to control the non-volatile storage device 16.

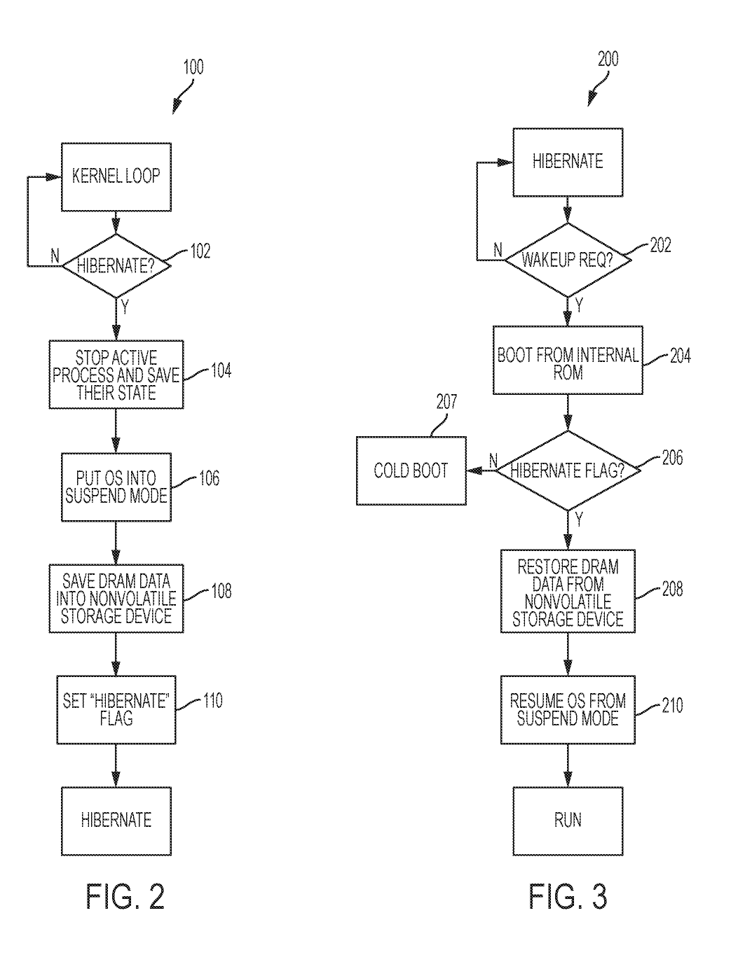

A proposed hibernation flow 100 in accordance with an embodiment of the present invention will now be described with reference to FIG. 2. In normal operation, the processor 12 will run the operating system kernel, during which application programs may be executed by the processor 12 within the operating system. When a request is received at step 102 to enter the computing device 10 into hibernation mode, the processor 12 at step 104 preferably ceases execution of any programs within the operating system and saves a state of each active program into the volatile system memory 14. The request may be explicitly selected by a user of the computing device 10, such as by selecting a displayed option to hibernate or the like. Alternatively, the request may be automatically received in response to a particular user action, such as pressing a power button, turning off an automobile, or the like. At step 106, the processor 12 preferably suspends execution of the operating system, similar to as if the computing device 10 were being placed into the “suspend” mode. Notably, the processor 12 does not create a snapshot of the operating system, as occurs in conventional hibernation flows. Thus, the operating system is kept “alive” in the volatile system memory 14.

At step 108, substantially the entire content of the volatile system memory 14 is copied into the non-volatile storage device 16. While it is intended that the entire volatile system memory 14 be copied over, it is within the scope of the invention to omit copying of irrelevant data for hibernation purposes. At the very least, the data related to the suspended operating system and the saved states of the active programs is copied to the non-volatile storage device 16. Preferably, a copy program is stored in the internal volatile memory 22 and executed by the processor 12 to enable the copying function.

A hibernate flag is stored in the internal non-volatile memory 24 at step 110, and at step 112, the processor 12 turns off the power to the computing device 10 and enters hibernation.

A proposed resumption flow 200 in accordance with an embodiment of the present invention will now be described with reference to FIG. 3. The computing device 10 remains in hibernation until a wake request is received at step 202, at which time power is restored to the computing device 10. The wake request may be in the form of the user pressing a power button, turning on an automobile, or the like. As is conventional, at step 204, the processor 12 executes the boot program from its internal ROM 20. At step 206, the processor 12 checks whether the hibernate flag is set in the internal non-volatile memory 24. If not, the processor 12 performs a cold boot at step 207 using the boot program. If the hibernate flag is set, resumption from hibernation continues.

This practice differs markedly from previous hibernation resumption flows where the processor would not check for a hibernate flag until after a boot loader has executed and the operating system kernel has been initiated. According to embodiments of the present invention, starting the operating system kernel from an initial state is not necessary.

In particular, at step 208, the copied content in the non-volatile storage device 16 is restored to the volatile system memory 14. This may be performed by the copy program or a like program stored in the internal volatile memory 22. At step 210, execution of the operating system from its suspended state is resumed. That is, the processor 12 can follow the normal resumption from “suspend” mode to restore the user's session because the operating system was kept “alive” in the non-volatile storage device 16 during hibernation and has been restored to the volatile system memory 14.

The significant reduction in resumption time based on the above-described hibernation and resume flows 100, 200 can be seen in comparison with a standard LINUX hibernation method in a system utilizing a 256 MB DRAM and an 8-bit eMMC with 400 MB/s bus speed. In the standard LINUX resume flow following hibernation, it takes about 50 ms to perform the initial boot, about 1 second to execute the boot loader, and about 2 seconds to start the kernel and restore the snapshot of the kernel state from the eMMC. Thus, the resumption time is slightly more than 3 seconds.

In contrast, while the resume flow of the above-described embodiment still performs the initial boot at 50 ms, the boot loader and operating system start-up are avoided. Restoring the copied data from the eMMC to the DRAM takes only 640 ms, and a further 50 ms is taken to restore hardware and driver states. Thus, the system is returned to the user's previous session in less than a second.

Embodiments of the present invention are useful for many computing applications. In one example, e-readers typically do not offer a hibernation mode, and power consumption for suspend modes is high. With a resume time of less than one second, the hibernation mode in accordance with embodiments of the present invention may be used to increase battery life in an e-reader by ten times, or allow the battery size to be greatly reduced.

In another example, ANDROID-based auto infotainment systems take snapshots of the operating system which are static images, and user settings for preferences or favorites must be saved in other places and synchronized after boot. With the hibernation mode in accordance with embodiments of the present invention, the boot time is less than one second and all states of the operating system at the last “engine-off” moment can be automatically restored.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

In the claims, the word ‘comprising’ or ‘having’ does not exclude the presence of other elements or steps then those listed in a claim. Further, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

1. A method for conserving power in a computing device having a volatile system memory, a non-volatile storage device, and a processor executing an operating system and including an internal non-volatile memory, the method comprising:
receiving, at the processor, a request to enter the computing device into a hibernation mode;
suspending, by the processor, execution of the operating system;
copying, by the processor, substantially an entire contents of the volatile system memory into the non-volatile storage device;
storing, in the internal non-volatile memory of the processor, a hibernate flag; and
turning off power to the computing device.

2. The method of claim 1, further comprising:
restoring power to the computing device;
restoring, by the processor, the copied contents to the volatile system memory; and
resuming, by the processor, execution of the operating system from its suspended state.

3. The method of claim 2, wherein the processor further includes an internal read-only-memory storing a boot program, the method further comprising:
following restoration of power to the computing device, executing, by the processor, the boot program;
checking, by the processor, whether the hibernate flag is set in the internal non-volatile memory; and
only restoring the copied contents to the volatile system memory if the hibernate flag is set, wherein if the hibernate flag is not set, the processor performs a cold boot using the boot program.

4. The method of claim 1, wherein the non-volatile storage device is a flash memory.

5. The method of claim 4, wherein the flash memory is one of a Secure Digital (SD) card or an embedded MultiMediaCard (eMMC).

6. The method of claim 1, wherein the processor is configured to execute at least one program within the operating system, the method further comprising:
stopping, by the processor, execution of the at least one program and saving a state of the at least one program into the volatile system memory prior to suspension of execution of the operating system.

7. The method of claim 1, wherein the processor includes an internal volatile memory storing a copy program, and wherein the copying of the volatile system memory contents into the non-volatile storage device is performed by the processor by executing the copy program.

8. The method of claim 1, wherein the volatile system memory is a dynamic random access memory (DRAM).

9. A computing device, comprising:
a volatile system memory;
a non-volatile storage device; and
a processor executing an operating system and including an internal non-volatile memory, the processor being configured to:
receive a request to enter the computing device into a hibernation mode,
suspend execution of the operating system,
copy substantially an entire contents of the volatile system memory into the non-volatile storage device,
storing in the internal non-volatile memory, a hibernate flag, and
turn off power to the computing device.

10. The computing device of claim 9, wherein the processor is further configured to:
restore power to the computing device,
restore the copied content to the volatile system memory, and
resume execution of the operating system from its suspended state.

11. The computing device of claim 10, wherein the processor further includes an internal read-only-memory (ROM) that stores a boot program, and the processor is further configured to:
following restoration of power to the computing device, execute the boot program,
check whether the hibernate flag is set in the internal non-volatile memory; and
only restore the copied content to the volatile system memory if the hibernate flag is set, wherein if the hibernate flag is not set, the processor performs a cold boot using the boot program.

12. The computing device of claim 9, wherein the non-volatile storage device is a flash memory.

13. The computing device of claim 12, wherein the flash memory is one of a Secure Digital (SD) card or an embedded MultiMediaCard (eMMC).

14. The computing device of claim 9, wherein the processor is further configured to:
execute at least one program within the operating system, and
stop execution of the at least one program and save a state of the at least one program into the volatile system memory prior to suspension of execution of the operating system.

15. The computing device of claim 9, wherein the processor further includes an internal volatile memory that stores a copy program, and wherein the processor is further configured to copy the volatile system memory content into the non-volatile storage device by executing the copy program.

16. The computing device of claim 9, wherein the volatile system memory is a dynamic random access memory (DRAM).
